(19) United States
(12) Patent Application Publication
(10) Pub. No.: US 2010/0286576 A1
(43) Pub. Date: Nov. 11, 2010

(54) Photo Therapy and Massage Apparatus for Relieving Pain in Body Cavities

(75) Inventors: Brian Pryor, Newark, DE (US); Sean Xiaolu Wang, Wilmington, DE (US)

Correspondence Address: BWT PROPERTY, INC., 19 SHEA WAY, SUITE 301, NEWARK, DE, 19713, US

(73) Assignee: BWT PROPERTY, INC., Newark, DE (US)

(21) Appl. No.: 12/775,313

(22) Filed: May 6, 2010

Related U.S. Application Data
(60) Provisional application No. 61/175,957, filed on May 6, 2009.

(51) Int. Cl. A61H 7/00

(52) U.S. Cl. 601/18

(57) ABSTRACT

A photo therapy and massage apparatus for relieving pain in a patient's body cavity. The photo therapy and massage apparatus comprises a light source to produce therapeutic light and a hollow massage wand capable to be inserted into the patient's body cavity to provide mechanical massage to the tissue inside the body cavity. An optical light guide with its proximal end coupled to the light source and its distal end embedded in the hollow massage wand is used to deliver the therapeutic light from the light source to the massage wand. The distal end of the optical light guide is configured to emit the therapeutic light from a side surface. The therapeutic light then transmits through the hollow massage wand to treat the tissue inside the body cavity.

### REFERENCE TO RELATED APPLICATION

This application claims an invention which was disclosed in Provisional Patent Application No. 61/175,957, filed May 06, 2009, entitled “PHOTO THERAPY AND MASSAGE APPARATUS FOR RELIEVING PAIN IN BODY CAVITIES”. The benefit under 35 USC §119(e) of the above mentioned United States Provisional Applications is hereby claimed, and the aforementioned application is hereby incorporated herein by reference.

### FIELD OF THE INVENTION

This invention generally relates to a photo therapy and massage apparatus, and more specifically to a photo therapy and massage apparatus for relieving pain in body cavities.

### BACKGROUND

There are several medical conditions that cause pain in patients' body cavities. As one example, oral mucositis is an inflammatory condition of oral mucosa associated with severe pain arising from the chemotherapy agents that cancer patients must ingest as an adjunct to bone marrow transplant. As another example, there are large number of women suffer from pain in the vaginal canal, which is usually associated with an underlying medical and/or psychological condition. For instance, atrophic vaginitis (also known as vaginal atrophy), which is an inflammation of the vagina due to the thinning and shrinking of the tissues, is common for postmenopausal women as a result of decrease in estrogen level. Other examples include hemorrhoids in anus, chronic pelvic pain, dyspareunia (painful intercourse), overactive bladder, inflammation induced pain in tooth and gum, etc.

Photo therapy had been demonstrated to be capable of treating medical conditions inside a body cavity.

U.S. Pat. No. 4,998,930 issued to Lundahl discloses a method for applying laser radiation to destroy cancer cells residing on the internal surface of organs. The method includes the step of inserting a light transmission fiber into a catheter having a deflated translucent balloon that touches the inner wall of the organ and irradiating the internal wall of the organ with laser light that transmits out of the tip of the fiber.

U.S. Pat. No. 5,458,595 issued to Tadir et al. discloses a vaginal speculum that utilizes a precisely and accurately positionable optical fiber for performing photodynamic therapy of intraepithelial tissue and in particular vaginal, cervical, and vulvar neoplasia.

U.S. Pat. No. 7,144,247 issued to Black discloses a brush comprising a head with two or more light sources and multiple openings to concurrently apply two or more hygienic effects to structures in a body cavity.

This invention discloses a new photo therapy and massage apparatus for relieving pain in a patient's body cavity. Different from previous approaches, phototherapy and mechanical massage are applied to the tissue in a concerted manner and benefit from each other thereby producing significantly improved pain relieving results.

### SUMMARY OF THE INVENTION

A photo therapy and massage apparatus for relieving pain in a patient's body cavity. The photo therapy and massage apparatus comprises a light source to produce therapeutic light and a hollow massage wand capable to be inserted into the patient's body cavity to provide mechanical massage to the tissue inside the body cavity. An optical light guide with its proximal end coupled to the light source and its distal end embedded in the hollow massage wand is used to deliver the therapeutic light from the light source to the massage wand. The distal end of the optical light guide is configured to emit the therapeutic light from a side surface. The therapeutic light then transmits through the hollow massage wand to treat the tissue inside the body cavity.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 shows one exemplary embodiment of the photo therapy and massage apparatus.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a photo therapy and massage apparatus for relieving pain in body cavities. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

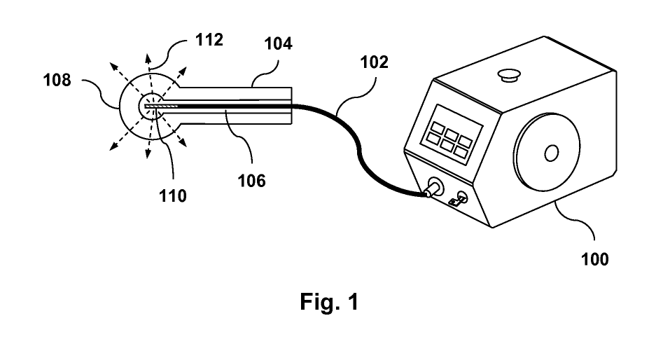

FIG. 1 shows one exemplary embodiment of the photo therapy and massage apparatus, which is used for relieving vaginal pain of a patient. The apparatus comprises a light source module 100, which may consist of lasers, light emitting diodes (LEDs), lamps or any of their combinations. The therapeutic light produced by the light source module 100 is coupled into the proximal end of an optical light guide 102, such as an optical fiber or a liquid light guide, and delivered to the distal end 110 of the light guide, which is embedded in a conduit 106 of a hollow massage wand 104. The massage wand 104 is capable to be inserted into the vaginal canal (not shown) of the patient. The distal end 110 of the optical light guide 102 is configured to emit the therapeutic light 112 from its side surface. This can be achieved by either replacing the cladding of the optical light guide with a diffusive coating or by polishing the end of the optical light guide to a conical shaped surface. Some examples can be found in U.S. Patent Nos. 5,431,647 and 5,429,635, which are hereby incorporated herein as references. In another variation, a small prism or a reflector (not shown) can be attached to the tip of the optical light guide 102 (or be integrated in the conduit 106 of the massage wand 104) and cause the therapeutic light to be emitted sideways. In yet another variation, the distal end 110 of the optical light guide 102 may be bended so that the therapeutic light emits out in an angle. The massage wand 104 is made of a material substantially transparent at the wavelength of the therapeutic light such that the therapeutic light 112 can transmit through it. The massage wand 104 further comprises a protuberance 108. When a force is applied onto the massage wand 104, the protuberance 108 executes rubbing and kneading massage to the vaginal tissue. In the mean time, the therapeutic light 112 that transmits through the massage wand 104 and the protuberance 108 provides photo therapy to the same vaginal tissue.

In this exemplary embodiment, the mechanical massage and photo therapy work in a concerted manner. The mechanical massage relaxes muscle spasms and relieves muscle tension, improves muscle tone and helps prevent or delay muscular atrophy. In addition, it causes an increase in blood circulation and fluid mobilization of the subcutaneous tissue, which helps to reduce tissue inflammation and relieve muscle pain. At the same time, the massage action also causes a reduction in tissue thickness and an increase in tissue density. This change in tissue property helps to reduce the overall absorption and scattering loss of the tissue and allows the therapeutic light 112 to penetrate deeper into the tissue and induce stronger photochemical processes. The photochemical processes in turn help to enhance the effect of the mechanical massage by modifying the conditions of the subject tissue, such as stimulating inter or intra cellular response, increasing micro-circulation, etc.

Depending on the output wavelength of the light source module 100, the therapeutic light 112 can provide a variety of treatment effects. The ultraviolet (UV)-blue light, at a wavelength of 370 to 490 nm, has high photon energy, which can help to produce singlet oxygen and effectively destroy bacteria. The red light, at a wavelength of 620 to 700 nm, can penetrate human tissue to a depth of about 8-10 mm. Skin layers, because of their high blood and water content, easily absorb red light, which helps to increase blood circulation and decrease inflammation/irritation. The near-infrared (NIR) light, at a wavelength of >700 nm, has been demonstrated to be beneficial for increasing cytochrome oxidase activity and ATP (adenosine triphosphate) content as well as promoting wound healing and relieving pain. In addition, the near-infrared light penetrates to a depth of about 30-40 mm, which makes it more effective for deep muscles. The light source module 100 may comprise multiple light sources with different output wavelengths, each wavelength matching with the absorption band of a specific chromophore (water, hemoglobin, lipid, protein, etc.) of the subject vaginal tissue. In addition to the above disclosed treatment effects, the therapeutic light 106 may be used to activate photosensitizing drugs for photodynamic therapy (PDT).

In a slight variation of the present embodiment, the massage wand 104 and the protuberance 108 may have an optically diffusive outer surface, which is capable of increasing the spread angle of the transmitted therapeutic light 112. When the massage wand 104 and the protuberance 108 are not in contact with the vaginal tissue, the increased spread angle of therapeutic light helps to reduce its light intensity thus enhances the safety level of the photo therapy apparatus. When the massage wand 104 and the protuberance 108 are in contact with the vaginal tissue, the therapeutic light is much less distorted or spread. This is due to the fact that the tissue in contact with the surface of the massage wand serves as an optical index matching medium, which effectively reduces diffusing or scattering of the therapeutic light. Hence, the therapeutic light is effectively delivered into the vaginal tissue with desired direction, spread angle, power density, depth, and intensity distribution.

In another variation of the present embodiment, the photo therapy and massage apparatus may further comprise a touch sensor or a pressure sensor to control the on/off status of the light source in such a way that the light source can only be turned on when the massage wand touches the vaginal tissue. This helps to improve the safety of the photo therapy apparatus by limiting inadvertent light exposure.

In yet another variation of the present embodiment, the photo therapy and massage apparatus may further comprise a temperature sensor to monitor the temperature of the vaginal tissue. The obtained temperature signal can be utilized for controlling the light energy that is delivered to the tissue. When the measured tissue temperature reaches dangerous or undesirable levels, a warning signal can be sent to the operator to shut down the light source module.

In yet another variation of the present embodiment, a motor may be installed in the massage wand 104 and mechanically coupled to the protuberance 108 to generate rolling, kneading, and/or vibration movements of the protuberance 108.

With some minor modifications to the size and shape of the massage wand, the photo therapy and massage apparatus can be used for relieving pain in other body cavities, such as oral, nasal, rectal, urinary, ear, and uterus cavities or other unnaturally formed body cavities.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A photo therapy and massage apparatus for relieving pain in a patient's body cavity, the photo therapy and massage apparatus comprising:
at least one light source to produce therapeutic light;
a hollow massage wand capable to be inserted into the patient's body cavity to provide mechanical massage to tissue inside the body cavity, said hollow massage wand being made of a material substantially transparent at wavelengths of said therapeutic light; and
at least one optical light guide with a proximal end coupled to said at least one light source and a distal end embedded in said hollow massage wand, wherein the distal end of said at least one optical light guide is configured to emit said therapeutic light through said hollow massage wand to treat the tissue inside the body cavity.

2. The photo therapy and massage apparatus of claim 1, wherein said therapeutic light and mechanical massage are applied to the tissue in a concerted manner, wherein said mechanical massage modifies a plurality of properties or conditions of the tissue to facilitate absorption or interaction of said therapeutic light with the tissue to improve effects of said therapeutic light, and said therapeutic light modifies a plurality of properties or conditions of the tissue to improve effects of said mechanical massage.

3. The photo therapy and massage apparatus of claim 1, wherein said at least one light source is selected from the group consisting of lasers, light emitting diodes (LEDs), and lamps.

4. The photo therapy and massage apparatus of claim 1, wherein said at least one light source comprises multiple light sources with different output wavelengths.

5. The photo therapy and massage apparatus of claim 1, wherein said at least one optical light guide comprises an optical fiber or a liquid light guide.

6. The photo therapy and massage apparatus of claim 1, wherein the distal end of said at least one optical light guide is configured to emit said therapeutic light from a side surface thereof.

7. The photo therapy and massage apparatus of claim 1, wherein said hollow massage wand comprises at least one protuberance.

8. The photo therapy and massage apparatus of claim 1, wherein said hollow massage wand has a diffusive optical surface capable of increasing a spread angle of said therapeutic light.

9. The photo therapy and massage apparatus of claim 1, further comprising a touch sensor to monitor a contact or pressure between said hollow massage wand and the tissue to obtain a contact or pressure signal, wherein the contact or pressure signal is utilized to control said at least one light source.

10. The photo therapy and massage apparatus of claim 1, further comprising a temperature sensor to monitor a temperature of the tissue and obtain a temperature signal, wherein said temperature signal is utilized to control said at least one light source.

11. A photo therapy and massage method for relieving pain in a patient's body cavity, the method comprising the steps of:
providing at least one light source to produce therapeutic light;
inserting a hollow massage wand into the patient's body cavity to provide mechanical massage to tissue inside the body cavity, said hollow massage wand being made of a material substantially transparent at wavelengths of said therapeutic light;
providing at least one optical light guide with a proximal end coupled to said at least one light source and a distal end embedded in said hollow massage wand; and
causing said therapeutic light to emit from the distal end of said at least one optical light guide and transmit through said hollow massage wand to treat the tissue inside the body cavity;
wherein said therapeutic light and mechanical massage are applied to the tissue in a concerted manner, wherein said mechanical massage modifies a plurality of properties or conditions of the tissue to facilitate absorption or interaction of said therapeutic light with the tissue to improve effects of said therapeutic light, and said therapeutic light modifies a plurality of properties or conditions of the tissue to improve effects of said mechanical massage.
